(19) United States
(12) Patent Application Publication
(10) Pub. No.: US 2007/0286173 A1
(43) Pub. Date: Dec. 13, 2007

(54) Interactive console for delivering digital network services to telephone networks

(75) Inventors: John Yu-Hsien Li, Saratoga, CA (US); Ta-Wei Chang, Taipei City (TW); Chen-Chou Lin, San Jose, CA (US)

Correspondence Address: COURTNEY STANIFORD & GREGORY LLP, P.O. BOX 9686, SAN JOSE, CA, 95157, US

(73) Assignee: BayHub, Inc

(21) Appl. No.: 11/439,698

(22) Filed: May 23, 2006

(51) Int. Cl. H04L 12/66

(52) U.S. Cl. 370/356

(57) ABSTRACT

Embodiments of a device for providing an interface to the Internet using standard analog telephones and household telephone lines are described. An interactive console incorporates a display panel, analog telephone adapter, broadband router, and wireless Internet protocol interface in an integrated housing. The interactive console connects to a standard analog telephone, and interfaces the telephone to an Internet protocol network. A server computer coupled to the Internet protocol network provides Internet and digital network services to users of the console, as well as interconnection to other server computers and resources on the Internet. The interactive console and server system thus provide an interface for existing telephone users to gain Internet intelligence and interact with the greater Internet community.

### FIELD

Embodiments of the invention relate generally to computer and telephone networks, and more specifically, to a system for delivering Internet and digital network services to telephone networks.

### BACKGROUND

The advent of the Internet and World Wide Web (WWW) has enabled a significant number of computer users to access global networks and take advantage of a great deal of resources and communication capabilities available on these networks. New websites are established on an almost daily basis, thus constantly increasing the information and resources available to web-enabled computer users. Even more significant however, is the adoption of the Internet by business and government entities as the primary interface with the public. Traditional businesses and organizations are increasingly utilizing the web as the basic foundation of interaction with their customers, thus making Internet access increasingly more important. Despite the pervasiveness of the web, relatively few users actually have access to or utilize the web at all, let alone on a regular basis. Although many households in the United States have at least one personal computer, only about one-quarter of these households are connected to the Internet. The emergence of services, such as Internet cafes provide web access to anyone who does not have a computer or network connectivity, but such services can be costly and very inconvenient to use.

A variety of different reasons exist for the lack of greater web use among the general public. Principle among these is the expense associated with Internet connectivity, including the cost of the computer and associated hardware and Internet Service Provider (ISP) subscription costs. Another reason is the complication or the perceived complication associated with setting up and maintaining an Internet account, as well as using a web browser program to access the Internet. A more basic reason for the under utilization of web access is perhaps the basic lack of computer literacy among significant segments of the population, such as low-income families or the elderly. The expense and relative complication of owning and using personal computers has created an “information gap” that continues to prevent many people from taking advantage of the resources and convenience of the Internet.

Access to the Internet, however, generally does not require the use of a personal computer, since it remains primarily a telephone infrastructure-based network. Furthermore, most people today do not require the full web browser capability to perform most day-to-day tasks. Thus, providing effective Internet access does not necessarily require the use of a full computer system and associated networking hardware and services. What is needed instead is an electronic console with minimum processing capability that can be configured to provide a simplified and cost-effective interface to Internet-based or other digital network services that would be used by the majority of people most of the time. Such a device can also be configured to provide voice processing capability so that it can be deployed to the hundreds of millions of present telephone network subscribers, thus taking advantage of the broad deployment base of the well-established PSTN telephone network.

Although devices such as Internet phones have been developed to provide Internet access using digital telephones, such devices do not provide access to the full range of services and resources available. Consumers today can order Voice over IP (VoIP) services from digital voice Service Providers. These services provide an Analog Telephone Adapter (ATA) box so that the user can talk over current IP networks at typically lower rates than what are available through the standard telephone networks. These services provide the necessary analog to digital voice conversion, but they do not provide any Internet intelligence and convenience to the user.

What is needed therefore, is a device that provides Internet intelligence and convenience to users through the present widely deployed existing telephone systems.

What is further needed is a system that provides a full Internet experience to users who have telephone connectivity, but that does not require the use of personal computers or similar processing systems.

### BRIEF SUMMARY OF THE INVENTION

Embodiments of a system for providing an interface to existing telephone users to gain Internet intelligence and interact with the Internet community is described. An interactive console with minimum processing capability is configured to provide basic Internet access through an existing telephone network connection in a home. The interactive console incorporates a display panel, analog telephone adapter, broadband router, and wireless Internet protocol interface in an integrated housing. The interactive console connects to a standard analog telephone, and interfaces the telephone users to an Internet protocol network. A server computer coupled to the Internet protocol network provides digital network services to users of the console, as well as interconnection to other network servers and resources on multiple other networks including, but not limited to the Internet, mobile networks, and other Local Area Networks (LANs) or Wide Area Networks (WANs). The interactive console comprises a simple circuit board that incorporates a minimum number of digital signal processing circuits and associated network connectivity circuits to provide a low-cost Internet access solution that is easy to use, as well as inexpensive to build and deploy.

Other objects, features, and advantages of the embodiments described herein will be apparent from the accompanying drawings and the detailed description that follows below.

### BRIEF DESCRIPTION OF THE DRAWINGS

Embodiments of the present invention are illustrated by way of example and not limitation in the figures of the accompanying drawings, in which like references indicate similar elements, and in which:

FIG. 1 is a block diagram of a computer and telephone network system that implements embodiments of an interactive console.

FIG. 2 illustrates an interactive console coupled to an analog telephone, under an embodiment.

FIG. 3 is a block diagram of an interactive console for coupling an analog telephone to an Internet protocol network, according to an embodiment.

FIG. 4 is a block diagram of a circuit board for an interactive console, according to an embodiment.

### DETAILED DESCRIPTION

Embodiments of an interactive console for interfacing an analog telephone to digital networks, and a server computer delivering digital network and Internet services to the interactive console are described. In the following description, numerous specific details are introduced to provide a thorough understanding of, and enabling description for, embodiments of the interactive console. One skilled in the relevant art, however, will recognize that these embodiments can be practiced without one or more of the specific details, or with other components, systems, and so on. In other instances, well-known structures or operations are not shown, or are not described in detail, to avoid obscuring aspects of the disclosed embodiments.

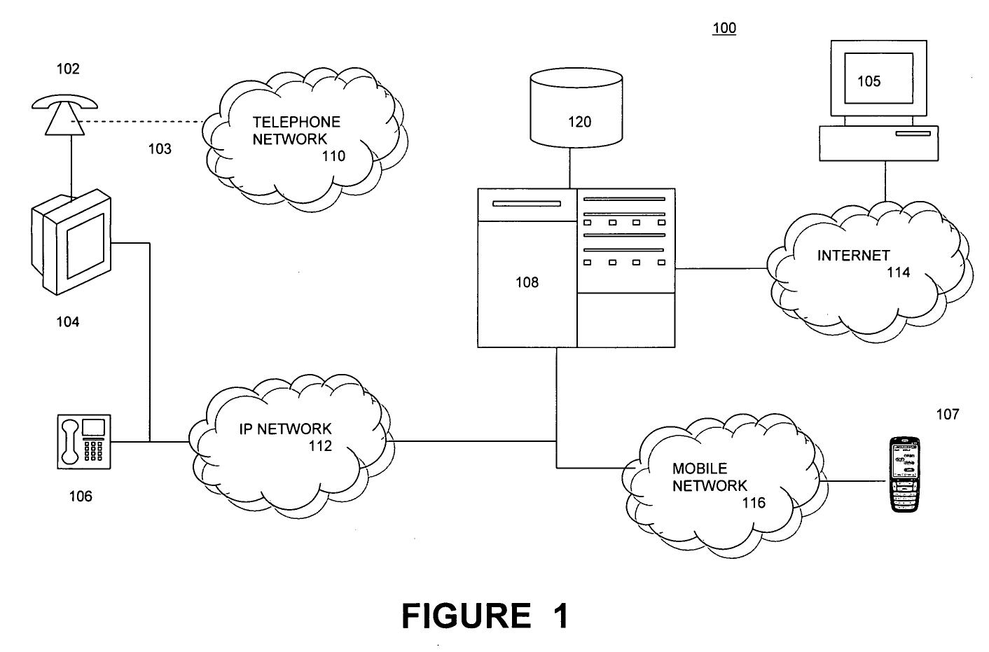

FIG. 1 illustrates a computer and telephone system 100 that implements one or more embodiments. In system 100, an analog telephone 102 is connected to a standard telephone network 110. The telephone network may be a Public Switched Telephone Network (PSTN) based on copper wires carrying analog voice data, or it may be a copper or fiber-based network using digital technologies, such as ISDN and FDDI. For the embodiment of FIG. 1, the analog telephone is also coupled to an Internet protocol (IP) network 112 through an interactive console 104, which comprises an integrated flat-panel display and housing containing circuitry necessary to adapt the analog voice signals of the telephone 102 to the digital signals required for the IP network 112. The IP network 112 can be connected to other Internet enabled resources, such as IP phone 106, and other network servers that may be coupled to the other networks, such as the Internet 114. The interactive console provides connectivity of telephone 102 to resources and devices coupled to this network, and thus serves to connect the PSTN phone users either directly to the Internet 114 or indirectly to the Internet, such as through IP network 112. In one embodiment, a server computer 108 is coupled to IP network 112 and provides an interface to other networks such as the Internet 114 and mobile network 116. Various other devices, such as computer 105 and mobile phone 107 may in turn be coupled to these other networks. The server computer 108 can be configured to provide services or data to the user of telephone 102 using the IP network interface or Internet graphical interface provided by interactive console 104. The data and resources served by server 108 can be locally stored, such as on closely coupled data store 120, or they may be provided by other devices, such as computer 105, or the server over other networks, such as the Internet 114. In one embodiment, the server computer 108 includes a client sensitive interface-rendering-engine that detects the client-side device type (e.g., personal computer, mobile phone, or interactive console, and so on), renders the appropriate graphical components accordingly, and delivers those graphical components over the IP network 112 to the client device, such as interactive console 104. For this embodiment, the interactive console is a client-side console that can access other network resources, such as converted Internet content or web compatible pages served by server computer 108 and any available content provider or supplemental server, such as computer 105 or other network server 109. Alternatively, the server computer 108 can adapt the web content available over the Internet 114 to a simpler graphic and text based protocol used by the interactive console 104.

In one embodiment, if full voice and data traffic to the analog phone 102 is handled by the interactive console 104, the old connection 103 between the telephone 102 and the PSTN network 110 can be eliminated. If the PSTN network operator requires that some traffic, such as voice traffic use portions of network 110 for operation of telephone 102 by the user, then a connection can be made between IP network 112 and PSTN network 110 for the user, but all physical traffic will still route to the phone 102 through the interactive console 104. In an alternative embodiment, the telephone 102 and interactive console 104 can be directly coupled to the Internet 114. In general, network 112 represents a dedicated IP network that comprises a leased pipe connecting two routers, and network 114 represents the Internet, which is a combination of all such IP networks. Coder/decoder (CODEC) circuits within the network devices encrypt and compress the data for transmission over the networks and adapt the quality of service to the appropriate levels.

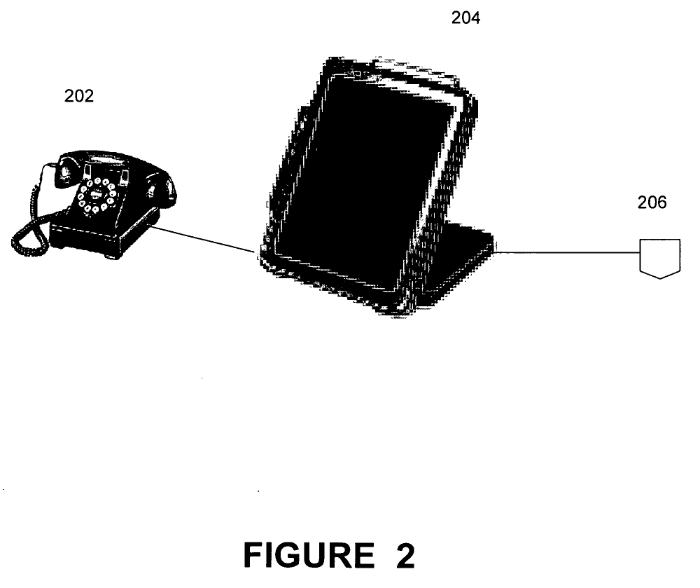

FIG. 2 illustrates an interactive console coupling an analog telephone to an Internet network, under an embodiment. The interactive console 204 comprises a touch screen display panel integrally coupled to or formed with a housing. The housing includes one or more input port for connection to an analog telephone 202, and one or more output ports for connection to a digital IP network. The housing includes a number of components to adapt the signals generated by the telephone to digital signals required by the IP network and to display the processed Internet content or other network resources to the end user.

The actual configuration of the housing can vary depending on the design parameters, such as size, weight, and shape. The console can be made as flat as possible with a stand for table or floor mounting or with hooks for wall mounting, or it could be like formed as a more cube-shaped device, such as a traditional CRT monitor, or any other similar configuration.

For the embodiment illustrated in FIG. 2, a first output port provides a coupling for the interactive console 204 to a standard telephone jack 206. This port may be a 10BaseT or similar port for providing a wired connection into the IP network through the standard telephone lines that may exist in the user's house, or it could tap into a digital telephone line, cable Internet, Ethernet line, or similar infrastructure that might be available in the house, through embedded adapters. The interactive console 204 can also include a second output port for connection to the IP network.

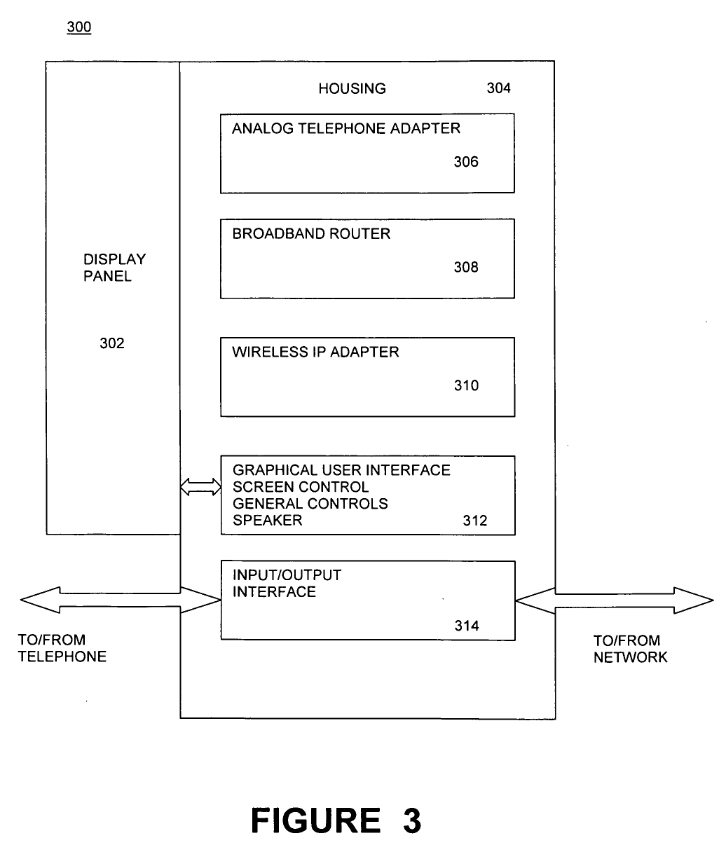

As stated above, the interactive console comprises a housing that integrates and contains a number of different hardware components or circuits that adapt the analog signals of the phone 102 to the digital signals of the IP network 112. FIG. 3 is a block diagram of an interactive console for coupling an analog telephone to an Internet network, according to an embodiment. Display panel 302 is connected to a housing 304. The housing 304 contains one or more circuits that embody an analog telephone adapter 306, a broadband adapter 308, and a wireless IP adapter 310. The interactive console may also contain several ancillary components 312, such as a speaker or speakers, picture controls to control the display characteristics (e.g., brightness, contrast, color, etc.) of the display panel 302, and other general controls, such as sound control, and so on. One such control can be a zoom in/out control that allows the user to magnify a portion of the screen for easier viewing. The interactive console also includes a communication input/output component that recognizes and processes user input and sends it to the server for further processing, and receives the response or request from server to provide graphical or audio output through the display or speaker. For this embodiment, input to the console can be provided in the form of direct user input through the touch screen panel by either finger touch or stylus. Alternatively, a speech recognizer can be used to receive spoken commands or input from the user. A graphical user interface component controls the user interaction and the processing of the input/output signals to and from the display screen and ancillary devices, such as speakers, keyboards, and the like.

A signal input/output interface 314 receives and sends analog signals to the telephone. These signals are converted and conditioned by the other circuits within the housing to be adapted to the digital signals that are received and sent over the IP network. With reference to FIG. 2, the input/output interface 314 is physically coupled to the telephone cord from telephone 202 and also interacts with server 108 to gain Internet intelligence.

Each of the components within the interactive console 300 performs a specific and separate task regarding the conditioning of the signals between the phone and the network and the interface to the user. The analog telephone adapter 306 connects the analog telephone to a broadband network for voice over IP (VoIP) service. It provides the conversion from analog voice signals to IP packets and vice versa. It also delivers a dial tone and manages telephone call setup. For an embodiment in which the interactive console includes a wireless network interface such as a Bluetooth or WiFi (Wireless Fidelity) interface, the wireless IP adapter 310 interfaces the wireless signals to interact with the IP network. The broadband router component 308 forwards the data packets across the IP network to the other destinations.

In one embodiment, the display panel 302 comprises a touch screen panel that allows the user to input commands or make command selections through the touch screen. The display panel can be optionally configured to display a graphic alpha-numeric keyboard, such as a standard QWERTY keyboard to facilitate text input. Alternatively, it can include a handwriting recognition component to allow the user to input written text or commands directly into the console through the use of a stylus or similar touch tool.

The interactive console can also be fitted with a webcam or similar camera system to capture images of the user or the user's surroundings. If such a device is used in conjunction with other similar devices, such as video enabled Internet phones, then video conferencing features can also be used by the interactive console user. Home surveillance systems can also be cost-effectively implemented when the console system is combined with service intelligence to monitor the area around the console or any area of focus by the camera.

In one embodiment, the interactive console comprises a touch-sensitive display panel that is coupled to a housing that contains a single primary circuit board. The circuit board contains the circuitry necessary to implement the main functional blocks illustrated in FIG. 3. The circuit board no or very minimal processor capability to reduce manufacturing and deployment cost and complexity. For this embodiment, the interactive console is effectively a processor-less dumb terminal device that simply transmits user input to the server computer 108 over network 112 and receives data from the server computer and/or other network devices for display to the user.

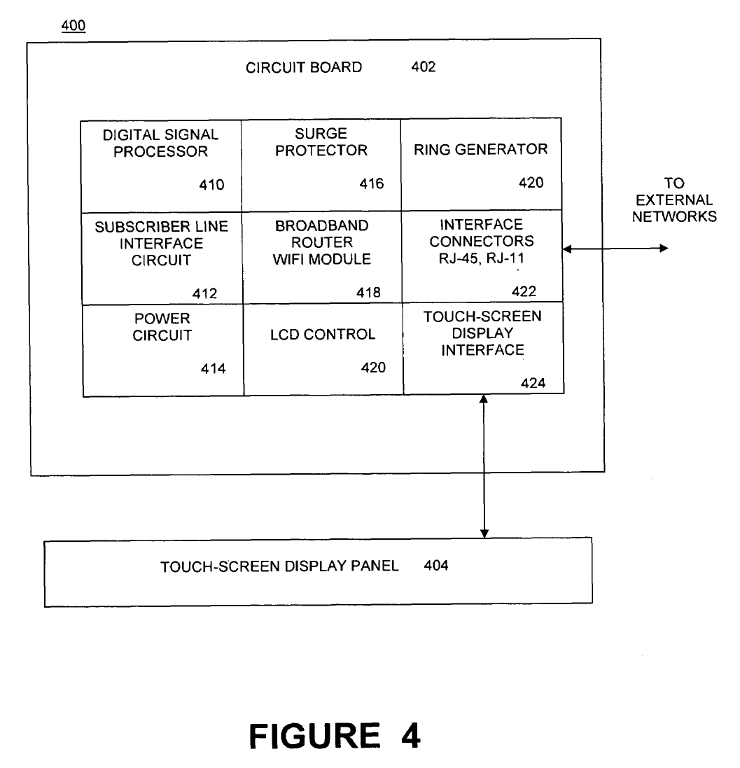

FIG. 4 is a block diagram of a circuit board for an interactive console, according to an embodiment. In one embodiment, the circuit board 402 contains one or more custom integrated circuit devices that are designed and configured to implement the functions illustrated in FIG. 4. The interactive console can be powered by either AC power or batter power. The electrical power is provided to the board 402 by a power circuit 414 and is conditioned by surge protector 416, which filters out sudden spikes or surges in power delivery. The subscriber line interface circuit (SLIC) 412 performs the analog-to-digital (A/D) conversion for the PSTN analog telephone to the digital IP network signals. The broadband router 418 transmits these signals to the IP network, as well as any signals provided by an optional wireless network adapter, such as a WiFi module. An LCD control circuit 420 and touch screen display interface 424 provide the signals for the touch screen display panel 404. Depending upon the implementation of the display panel interface, one or more of the LCD controls can be performed by software, such as by control commands shown on the user screen, or by hardware, such as by switches on the console. Interface connectors, such as RJ-45 and RJ-11 jacks 422 provide the means of physically interfacing the interactive console to the external networks.

In some applications, the interactive housing can be configured to operate as a stand-alone device without a telephone. In this case, the interactive console is configured to provide basic voice services, such as voice input/output. An optional headset adapter might be provided in the housing to facilitate the connection to an external headset/microphone or handset for voice input. For this embodiment, a ring generator 420 is provided to produce the ring signal for incoming calls.

For the embodiment illustrated in FIG. 4, the circuit board 402 also contains one or two digital signal processing (DSP) circuits. The DSP circuit 410 provides the logic circuitry to integrate and coordinate all of the other circuits on the board. In general, the DSP circuit includes sub-circuits that include, but are not limited to, the following functions: CODEC (coder/decoder) logic for functions such as DTMF and tone; fax/modem capability (e.g., V.34NV.90), VoIP services, such as caller ID, call blocking, call waiting, and so on; IP protocol functions, such as gatekeeper/SIP/proxy; PSTN backup lines, and basic Quality of Service functions, among others.

Certain functions, such as video processing of signals provided by the optional webcam can be implemented through logic included within DSP 410 or other circuitry on the circuit board. Likewise, the handwriting recognition or text conversion program can be implemented through dedicated circuitry or by logic programmed into the DSP. Besides the circuits illustrated in FIG. 4, several other circuits or integrated circuit devices can be included to enhance connectivity of the interactive console to the external networks. For example, the board could include a digital television receiver circuit for receiving digital television signals transmitted by television transmitters.

In one embodiment, the interactive console is coupled through the Internet network to a server computer 108 that provides a variety of services and resources to the user of the telephone. The server computer can be configured to provide access to any number of web servers or web resources, or it can be configured to provide data and/or services to the user itself. In this case, the server is coupled to one or more data storage units, such as data store 120 to store processed data related to any number of services and/or products or resources. Such items can include, but are not limited to, bank account management, travel agency services (airline ticketing, car rentals, hotel reservations), yellow page services, stock market information, event ticketing, bill paying service, messaging services, weather and traffic monitoring, television guide, and so on.

The server computer 108 can be configured to also provide resources that are tailored to specific groups or types of users. For example, a server that is deployed for use by senior citizens might include a variety of services used by this group, such as personal health monitoring, social security interface, emergency messaging and alerts, medication information, home surveillance, and the like.

The server computer can also be deployed in a business environment to provide several various business services. These can include, but are not limited to, voice/video phone capability, contact and messaging management, calendar/docket capability, to-do list functions, smart conferencing, project management and status monitoring, report generation, interactive white board, business yellow pages, and so on.

The interactive console brings Internet intelligence and convenience to end users through the existing telephone networks and the literally hundreds of millions of presently deployed telephone connections. The server component allows all of the computing to be done remotely at hosted servers, thus allowing the locally installed interactive console to be built with minimum processing power, hence at very low or perhaps even no cost to consumers. This two-way interactive console thus provides a new venue for non-PC-savvy general public to not only convert their analog voice data to digital data, but more importantly to gain intelligence and interact with other individuals and businesses from the Internet world.

As illustrated in FIG. 1, the server 108 can be configured to interface several different types of client devices to one another. Data can thus be provided to many different types of devices, each capable or limited to displaying data in a certain format given constraints of their displays and their communication circuits. In one embodiment, the server computer includes a client-sensitive rendering engine that detects the type of client that is producing a service request and tailors the content depending on the client type. This content can either be obtained from other network servers or resources, or it could be stored or generated by the server computer 108 itself.

In one embodiment, the client-sensitive rendering engine includes or has access to a database that stores all of the various possible client devices. Information relating to the characteristics of many different types of cellular phones, televisions, interactive consoles, and other possible display devices is stored in a self-populating table. This table lists all of the various different client devices, such as by brand and model and specifies the display characteristics for these devices. Upon interfacing with a particular client computer, the server computer will interrogate the list to match the output format to the characteristics of the client computer. A default content output style can be defined in the event that a client device is not of a recognized type. In this case, the text can be output can be displayed as a single line of text with no graphics attached. Rich content files can be processed to remove unsupportable data types. This list can be preprogrammed with all of the known current cellular phone, PDA, interactive console devices, and so on, or it can be populated through a handshake protocol that informs the server of the display parameters (e.g., screen size, graphics support, and so on), and the transmission capabilities of the client. In one embodiment, the interactive console display parameters are hardwired in the DSP circuit directly.

Embodiments of the interactive console described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects of the application integration method include: microcontrollers with memory (such as EEPROM), embedded microprocessors, firmware, software, etc. Furthermore, aspects of the described device may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the interactive console is not intended to be exhaustive or to limit the embodiments to the precise form or instructions disclosed. While specific embodiments of, and examples for, the system are described herein for illustrative purposes, various equivalent modifications are possible within the scope of the described embodiments, as those skilled in the relevant art will recognize.

The elements and acts of the various embodiments described above can be combined to provide further embodiments. These and other changes can be made to the interactive console in light of the above detailed description.

In general, in any following claims, the terms used should not be construed to limit the described system to the specific embodiments disclosed in the specification and the claims, but should be construed to include all operations or processes that operate under the claims. Accordingly, the described device is not limited by the disclosure, but instead the scope of the recited method is to be determined entirely by the claims.

While certain aspects of the interactive console are presented below in certain claim forms, the inventor contemplates the various aspects of the methodology in any number of claim forms. For example, while only one aspect of the system is recited as embodied in machine-readable medium, other aspects may likewise be embodied in machine-readable medium. Accordingly, the inventor reserves the right to add additional claims after filing the application to pursue such additional claim forms for other aspects of the described systems and methods.

What is claimed is:

1. A device for connecting an analog telephone to an Internet protocol network, comprising:
a display panel; and
an integrated housing coupled to the display panel, the housing including:
an analog telephone adapter,
a broadband router, and
a wireless Internet Protocol adapter.

2. The device of claim 1 wherein the display panel comprises a touch-screen flat panel display configured to accept user input through stylus or finger contact.

3. The device of claim 2, wherein the display panel is configured to display a virtual QWERTY keyboard for text entry by a user.

4. The device of claim 1 further comprising ring generation and audio input/output circuitry for operation as a standalone telephone and display device.

5. The device of claim 1 further comprising one or more speakers for output of audio signals to the user.

6. The device of claim 1 wherein a server computer is coupled to the Internet protocol network, the server computer configured to provide one or more Internet-based services to a user of the device.

7. The device of claim 6 wherein the services are provided to the user through a web-based interface displayed on the display panel.

8. A system for connecting an analog telephone to an Internet protocol network, comprising:
a telephone;
a client-side interactive console coupled to the telephone, the interactive console including an input/output component connecting the telephone to a digital network;
a server computer coupled to the digital network, the server computer configured to adapt and transmit digital content data to a user of the telephone.

9. The system of claim 8 wherein the interactive console comprises:
a display panel for providing graphical user output to the user;
one or more speakers for providing audio output to the user; and
an integrated housing coupled to the display panel, the housing including:
an analog telephone adapter,
a broadband router, and
a wireless Internet Protocol adapter.

10. The system of claim 8 wherein the device of claim 1 wherein the display panel comprises a touch-screen flat panel display configured to accept user input through stylus or finger contact, further configured to display a virtual QWERTY keyboard for text entry by a user.

11. The system of claim 10 wherein the digital network is the Internet, and the server computer configured to provide one or more Internet-based services to the user.

12. The system of claim 11 wherein the services comprise at least one of: bank account management, travel agency services, yellow page services, stock market information, event ticketing, bill paying services, messaging services, weather monitoring, traffic monitoring, and entertainment event guides.

13. The system of claim 10 wherein the interactive console further comprises a digital camera configured to record still images or video clips of the user or area proximate the interactive console.

14. The system of claim 13 wherein the services further comprise at least one of a video conferencing service, and a home surveillance service.

15. The system of claim 11 wherein the server computer is configured to provide services specifically required by a definable group of users.

16. The system of claim 15 wherein the definable group of users is selected from the group consisting essentially of: senior citizens, high school students, college students, and profession based organizations.
